(19) United States
(12) Patent Application Publication
(10) Pub. No.: US 2023/0125256 A1
(43) Pub. Date: Apr. 27, 2023

(54) OPTICAL MODULATOR, PHASE SHIFTER, AND OPTICAL COMMUNICATION APPARATUS

(71) Applicant: Fujitsu Optical Components Limited, Kawasaki-shi (JP)

(72) Inventor: Masaki Sugiyama, Kawasaki (JP)

(73) Assignee: Fujitsu Optical Components Limited, Kawasaki-shi (JP)

(21) Appl. No.: 17/880,322

(22) Filed: Aug. 3, 2022

(30) Foreign Application Priority Data
Oct. 21, 2021 (JP) 2021-172266

(51) Int. Cl. G02F 1/225; G02F 1/21; G02F 1/01; H04B 10/548

(52) U.S. Cl. CPC G02F 1/225; G02F 1/212; G02F 1/0136; H04B 10/548

(57) ABSTRACT

An optical modulator includes an optical waveguide through which signal light passes, a split unit that splits the signal light that passes through the optical waveguide, and a pair of phase shifters each of which shifts a phase of signal light that is split by the split unit. Each of the phase shifters includes an in-shifter waveguide through which the signal light passes, and a heater electrode that heats the in-shifter waveguide in accordance with a driving voltage. The in-shifter waveguide includes an inbound waveguide for inputting the signal light coming from the split unit, an outbound waveguide for outputting the signal light, a folded waveguide that connects the inbound waveguide and the outbound waveguide. The heater electrode is arranged in the vicinity of the inbound waveguide and the outbound waveguide.

### CROSS-REFERENCE TO RELATED APPLICATION

This application is based upon and claims the benefit of priority of the prior Japanese Patent Application No. 2021-172266, filed on Oct. 21, 2021, the entire contents of which are incorporated herein by reference.

### FIELD

The embodiments discussed herein are related to an optical modulator, a phase shifter, and an optical communication apparatus.

### BACKGROUND

In an optical modulator, Mach-Zehnder modulators for four channels are integrated. Each of Mach-Zehnder interferometers (MZI) includes a radio frequency phase shifter (RFPS) and a direct current phase shifter (DCPS). The RFPS is, for example, an MZI that receives input of a high-speed signal with a bandwidth of several-dozen GHz and performs high-speed modulation. The DCPS is, for example, an MZI that includes a heater electrode, causes an electric current to flow through the heater electrode to heat an optical waveguide to thereby change a refractive index of the optical waveguide, and adjusts a phase of light. The optical modulator adjusts the electric current that flows through the heater electrode of the DCPS such that ON/OFF of an electric signal input to the RFPS corresponds to ON/OFF of an optical signal.

FIG. 15 is a block diagram illustrating an example of a conventional optical modulator. An optical modulator 100 illustrated in FIG. 15 includes an optical waveguide 111, an optical input unit 112, a first split unit 113, an X-polarization MZM (Mach-Zehnder Modulator) 114A (114), and a Y-polarization MZM 114B (114). The optical modulator 100 further includes a polarization rotator (PR) 115, a polarization beam combiner (PBC) 116, and an optical output unit 117.

The optical waveguide 111 includes an optical waveguide 111A, an optical waveguide 111B, and an optical waveguide 111C. The optical waveguide 111A is an optical waveguide that connects the optical input unit 112 and the first split unit 113. The optical waveguide 111B is an optical waveguide that connects a second multiplexing unit 127A (127) in the X-polarization MZM 114A and the optical output unit 117, and connects a second multiplexing unit 127B (127) in the Y-polarization MZM 114B and the optical output unit 117. The optical waveguide 111C is an optical waveguide that connects the first split unit 113 and the second multiplexing unit 127.

The optical input unit 112 receives input of laser light from a light source (not illustrated). The first split unit 113 optically splits the laser light coming from the optical input unit 112, and outputs the optically split laser light to the X-polarization MZM 114A and the Y-polarization MZM 114B.

The X-polarization MZM 114A performs quadrature amplitude modulation on the laser light, which has been split by the first split unit 113, by using an X-polarized data signal, and outputs signal light of an X-polarized IQ component to the PBC 116. The Y-polarization MZM 114B performs quadrature amplitude modulation on the laser light, which has been split by the first split unit 113, by using a Y-polarized data signal, and outputs signal light of a Y-polarized IQ component to the PR 115. The PR 115 performs polarization rotation on the signal light of the Y-polarized IQ component coming from the Y-polarization MZM 114B such that the signal light is converted to signal light of an X-polarized IQ component, and outputs the converted signal light of the X-polarized IQ component to the PBC 116. Further, the PBC 116 multiplexes the signal light of the X-polarized IQ component coming from the X-polarization MZM 114A and the converted signal light of the X-polarized IQ component coming from the PR 115, and outputs dual-polarized signal light to the optical output unit 117.

The X-polarization MZM 114A includes a second split unit 121A (121), two third split units 122 (122A), two RF-side MZMs 123 (123A and 123B), and two DC-side child MZMs 124 (124A and 124B). Further, the X-polarization MZM 114A includes two first multiplexing units 126 (126A and 126B), a DC-side parent MZM 125 (125A), and the second multiplexing unit 127 (127A).

Each of the third split units 122A splits laser light coming from the second split unit 121A and outputs the split laser light to each of RFPSs 141 in the RF-side MZM 123A. The RF-side MZM 123A includes two RF electrodes 128 and the two RFPSs 141. Each of the RFPSs 141 in the RF-side MZM 123A performs high-speed modulation on the laser light in accordance with a high-speed signal coming from the RF electrode 128, and outputs the laser light subjected to the high-speed modulation to each of child DCPSs 142 in the DC-side child MZM 124A.

The DC-side child MZM 124A includes two DC electrodes 130A (130) and the two child DCPSs 142. Each of the child DCPSs 142 in the DC-side child MZM 124A performs phase modulation on the laser light, which has been subjected to the high-speed modulation, in accordance with a data signal coming from the DC electrode 130A, and outputs signal light of an I component subjected to the phase modulation to the first multiplexing unit 126A. The first multiplexing unit 126A multiplexes the signal light of the I component coming from each of the child DCPSs 142, and outputs the multiplexed signal light of the I component to one of parent DCPSs 143 in the DC-side parent MZM 125A.

The DC-side child MZM 124B includes two DC electrodes 130A and two child DCPSs 142. Each of the child DCPSs 142 in the DC-side child MZM 124B performs phase modulation on the laser light, which has been subjected to the high-speed modulation, in accordance with a data signal coming from the DC electrode, and outputs signal light of a Q component subjected to the phase modulation to the first multiplexing unit 126B. The first multiplexing unit 126B multiplexes the signal light of the Q component coming from each of the child DCPSs 142, and outputs the multiplexed signal light of the Q component to the other one of the parent DCPS 143 in the DC-side parent MZM 125A.

The DC-side parent MZM 125A includes two DC electrodes 130B (130) and the two parent DCPSs 143. One of the parents DCPS 143 in the DC-side parent MZM 125A performs quadrature modulation on the signal light of the I component, which has been subjected to the phase modulation, in accordance with a driving voltage signal coming from the DC electrode 130B, and outputs signal light of an X-polarized I component subjected to the quadrature modulation to the second multiplexing unit 127A. The other one of the parent DCPSs 143 in the DC-side parent MZM 125A performs quadrature modulation on the signal light of the Q component, which has been subjected to the phase modulation, in accordance with a driving voltage signal coming from the DC electrode 130B, and outputs signal light of an X-polarized I component subjected to the quadrature modulation to the second multiplexing unit 127A.

The second multiplexing unit 127A multiplexes the signal light of the X-polarized I component coming from the one of the parent DCPSs 143 in the DC-side parent MZM 125A and the signal light of the X-polarized Q component coming from the other one of the parent DCPSs 143 in the DC-side parent MZM 125A. Then, the second multiplexing unit 127A outputs the multiplexed signal light of the X-polarized IQ component to the PBC 116.

The Y-polarization MZM 114B includes a second split unit 121B (121), two third split units 122B (122), two RF-side MZMs 123 (123C and 123D), and two DC-side child MZMs 124 (124C and 124D). The Y-polarization MZM 114B includes two first multiplexing units 126 (126C and 126D), a DC-side parent MZM 125 (125B), and a second multiplexing unit 127 (127B).

Each of the third split units 122B splits laser light coming from the second split unit 121B and outputs the split laser light to each of RFPSs 141 in the RF-side MZM 123C. The RF-side MZM 123C includes two RF electrodes 128 and the two RFPSs 141. Each of the RFPSs 141 in the RF-side MZM 123C performs high-speed modulation on the laser light in accordance with a high-speed signal coming from the RF electrode 128, and outputs the laser light subjected to the high-speed modulation to each of child DCPSs 142 in the DC-side child MZM 124C.

The DC-side child MZM 124C includes two DC electrodes 130A (130) and the two child DCPSs 142. Each of the child DCPSs 142 in the DC-side child MZM 124C performs phase modulation on the laser light, which has been subjected to the high-speed modulation, in accordance with a data signal coming from the DC electrode 130A, and outputs signal light of an I component subjected to the phase modulation to the first multiplexing unit 126C. The first multiplexing unit 126C multiplexes the signal light of the I component coming from each of the child DCPSs 142, and outputs the multiplexed signal light of the I component to one of parent DCPSs 143 in the DC-side parent MZM 125B.

The DC-side child MZM 124D includes two DC electrodes 130A and two child DCPSs 142. Each of the child DCPSs 142 in the DC-side child MZM 124D performs phase modulation on the laser light, which has been subjected to the high-speed modulation, in accordance with a data signal coming from the DC electrode, and outputs signal light of a Q component subjected to the phase modulation to the first multiplexing unit 126D. The first multiplexing unit 126D multiplexes the signal light of the Q component coming from each of the child DCPSs 142, and outputs the multiplexed signal light of the Q components to the other one of the parent DCPSs 143 in the DC-side parent MZM 125B.

The DC-side parent MZM 125B includes two DC electrodes 130B (130) and the two parent DCPSs 143. One of the parent DCPSs 143 in the DC-side parent MZM 125B performs quadrature modulation on the signal light of the I component, which has been subjected to the phase modulation, in accordance with a driving voltage signal coming from the DC electrode 130B, and outputs signal light of a Y-polarized I component subjected to the quadrature modulation to the second multiplexing unit 127B. The other one of the parent DCPSs 143 in the DC-side parent MZM 125B performs quadrature modulation on the signal light of the Q component, which has been subjected to the phase modulation, in accordance with a driving voltage signal coming from the DC electrode 130B, and outputs signal light of a Y-polarized Q component subjected to the quadrature modulation to the second multiplexing unit 127B.

The second multiplexing unit 127B multiplexes the signal light of the Y-polarized I component coming from the one of the parent DCPSs 143 in the DC-side parent MZM 125B and the signal light of the Y-polarized Q component coming from the other one of the parent DCPSs 143 in the DC-side parent MZM 125B. Then, the second multiplexing unit 127B outputs the multiplexed signal light of the Y-polarized IQ component to the PR 115. The PR 115 performs polarization rotation on the signal light of the Y-polarized IQ component coming from the second multiplexing unit 127B, and outputs the signal light of the X-polarized IQ component subjected to the polarization rotation to the PBC 116. The PBC 116 performs polarization multiplexing on the signal light of the X-polarized IQ component coming from the second multiplexing unit 127A and the signal light of the X-polarized IQ component coming from the PR 115, and outputs a dual-polarized signal from the optical output unit 117.

However, in the optical modulator 100 illustrated in FIG. 15, for example, waveguide lengths of optical waveguides of the respective MZMs from the second split unit 121A to the second multiplexing unit 127A in the X-polarization MZM 114A and waveguide lengths of optical waveguides of the respective MZMs from the second split unit 121B to the second multiplexing unit 127B in the Y-polarization MZM 114B are different. If the waveguide lengths of the optical waveguides of the respective MZMs are different, an optical length difference occurs among the MZMs in accordance with a waveguide length difference. An optical loss and a driving voltage of each of the MZMs vary depending on the optical length difference among the MZMs. To cope with this, a technology for arranging an adjustment unit for adjusting the waveguide lengths such that the waveguide lengths of the optical waveguides of the respective MZMs in the X-polarization MZM 114A and the waveguide lengths of the optical waveguides of the respective MZMs in the Y-polarization MZM 114B become equal to one another is known.

FIG. 16 is a schematic plan view illustrating an example of a configuration of a conventional optical modulator 100A. Meanwhile, the same components as those of the optical modulator 100 illustrated in FIG. 15 are denoted by the same reference symbols, and explanation of the same components and operation will be omitted. The optical modulator 100A illustrated in FIG. 16 is different from the optical modulator 100 illustrated in FIG. 15 in that an adjustment unit 140 that adjusts waveguide lengths of folded waveguides between the child DCPSs 142 and the first multiplexing units 126 is provided. The adjustment unit 140 adjusts the waveguide lengths of the folded waveguides such that the waveguide lengths of all of the optical waveguides between the child DCPSs 142 and the first multiplexing units 126 become equal to one another.

The adjustment unit 140 is a folded waveguide that equalizes the waveguide lengths of all of the optical waveguides from the second split unit 121A to the second multiplexing unit 127 in the X-polarization MZM 114A and the waveguide lengths of all of the optical waveguides from the second split unit 121B to the second multiplexing unit 127B in the Y-polarization MZM 114B. Similarly, the adjustment unit 140 is a folded waveguide that equalizes the waveguide lengths of all of the optical waveguides from the second split unit 121A to the second multiplexing unit 127A in the X-polarization MZM 114A. Similarly, the adjustment unit 140 is a folded waveguide that equalizes the waveguide lengths of all of the optical waveguides from the second split unit 121B to the second multiplexing unit 127B in the Y-polarization MZM 114B. As a result, by adjusting the folded waveguide, the waveguide lengths of all of the optical waveguides between the child DCPSs 142 and the first multiplexing units 126 become equal to one another, so that it is possible to provide, for example, the optical modulator 100A that is stable and that avoids wavelength dependence.

Patent Literature 1: Japanese Laid-open Patent Publication No. 2013-3442

Patent Literature 2: Japanese Laid-open Patent Publication No. 2000-235169

Patent Literature 3: Japanese Laid-open Patent Publication No. 2019-152732

Patent Literature 4: United States Unexamined Patent Application Publication No. 2014/0212092

However, an arrangement space for arranging the adjustment unit 140 is needed in the optical modulator 100A, and therefore, a chip size of the entire optical modulator 100A increases. In addition, a total length of the optical waveguide is increased, so that an optical loss increases, and, in particular, if the number of channels is large, power consumption of a heater electrode increases. Therefore, there is a need for an optical modulator for which it is possible to reduce a size and it is possible to equalize waveguide lengths of all of optical waveguides in the optical modulator.

### SUMMARY

According to an aspect of an embodiment, an optical modulator includes an optical waveguide through which signal light passes, a split unit that splits the signal light that passes through the optical waveguide, and a pair of phase shifters, each shifting a phase of signal light that is split by the split unit. Each of the phase shifters includes an in-shifter waveguide through which the signal light passes, and a heater electrode that heats the in-shifter waveguide in accordance with a driving voltage. The in-shifter waveguide includes an inbound waveguide for inputting the signal light coming from the split unit, an outbound waveguide for outputting the signal light, and a folded waveguide that connects the inbound waveguide and the outbound waveguide. The heater electrode is arranged in a vicinity of the inbound waveguide and the outbound waveguide.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram illustrating an example of a configuration of an optical communication apparatus according to a first embodiment;

FIG. 2 is a schematic plan view illustrating an example of a configuration of an optical modulator;

FIG. 3 is a schematic plan view illustrating an example of a configuration of a child DCPS:

FIG. 4 is a schematic cross-sectional view illustrating an example of a cross section taken along a line A-A illustrated in FIG. 3;

FIG. 5 is a schematic cross-sectional view illustrating an example of a cross section taken along a line B-B illustrated in FIG. 3;

FIG. 6 is a schematic plan view illustrating an example of a configuration of an optical modulator according to a second embodiment;

FIG. 7 is a schematic plan view illustrating an example of a configuration of a child DCPS;

FIG. 8 is a schematic cross-sectional view illustrating an example of a cross section taken along a line C-C illustrated in FIG. 7;

FIG. 9 is a schematic plan view illustrating an example of a configuration of an optical modulator according to a third embodiment;

FIG. 10 is a schematic plan view illustrating an example of a configuration of a child DCPS;

FIG. 11 is a schematic cross-sectional view illustrating an example of a cross section taken along a line D-D illustrated in FIG. 10;

FIG. 12 is a schematic plan view illustrating an example of a configuration of an optical modulator according to a fourth embodiment;

FIG. 13 is a schematic plan view illustrating an example of a configuration of an optical modulator according to a fifth embodiment;

FIG. 14 is a schematic plan view illustrating an example of a configuration of an optical modulator according to a sixth embodiment;

FIG. 15 is a schematic plan view illustrating an example of a configuration of a conventional optical modulator; and

FIG. 16 is a schematic plan view illustrating an example of a configuration of a conventional optical modulator.

### DESCRIPTION OF EMBODIMENTS

Preferred embodiments of the present invention will be explained with reference to accompanying drawings. The present invention is not limited by the embodiments below.

### [a] First Embodiment

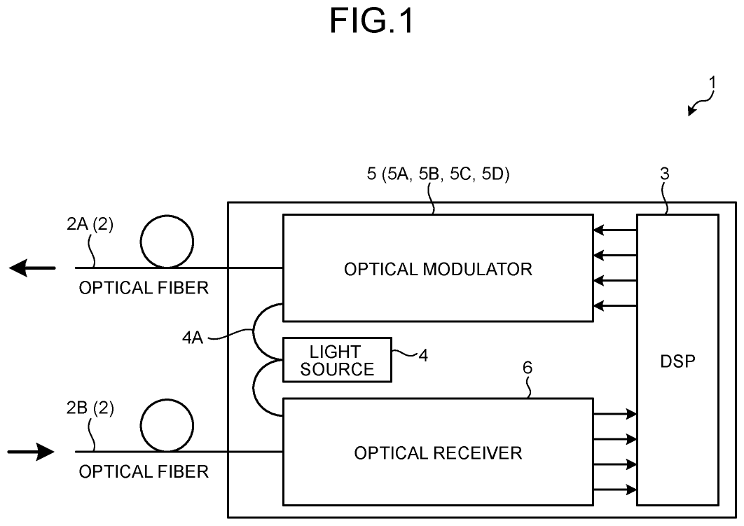

FIG. 1 is a block diagram illustrating an example of a configuration of an optical communication apparatus according to a first embodiment. An optical communication apparatus 1 illustrated in FIG. 1 is an optical coherent transceiver that is connected to an optical fiber 2A (2) at an output side and an optical fiber 2B (2) at an input side, for example. The optical communication apparatus 1 includes a digital signal processor (DSP) 3, a light source 4, an optical modulator 5, and an optical receiver 6. The DSP 3 is an electric component that performs digital signal processing. The DSP 3 performs certain processing, such as encoding, on transmission data, and outputs a data signal corresponding to the transmission data subjected to the processing to the optical modulator 5. Further, the DSP 3 performs certain processing, such as decoding, on reception data that corresponds to a data signal acquired from the optical receiver 6.

The light source 4 is, for example, an integrated tunable laser assembly (ITLA) that includes, for example, a wavelength tunable laser diode or the like, generates light at a predetermined wavelength, and supplies the light to the optical modulator 5 and the optical receiver 6 through a fiber 4A.

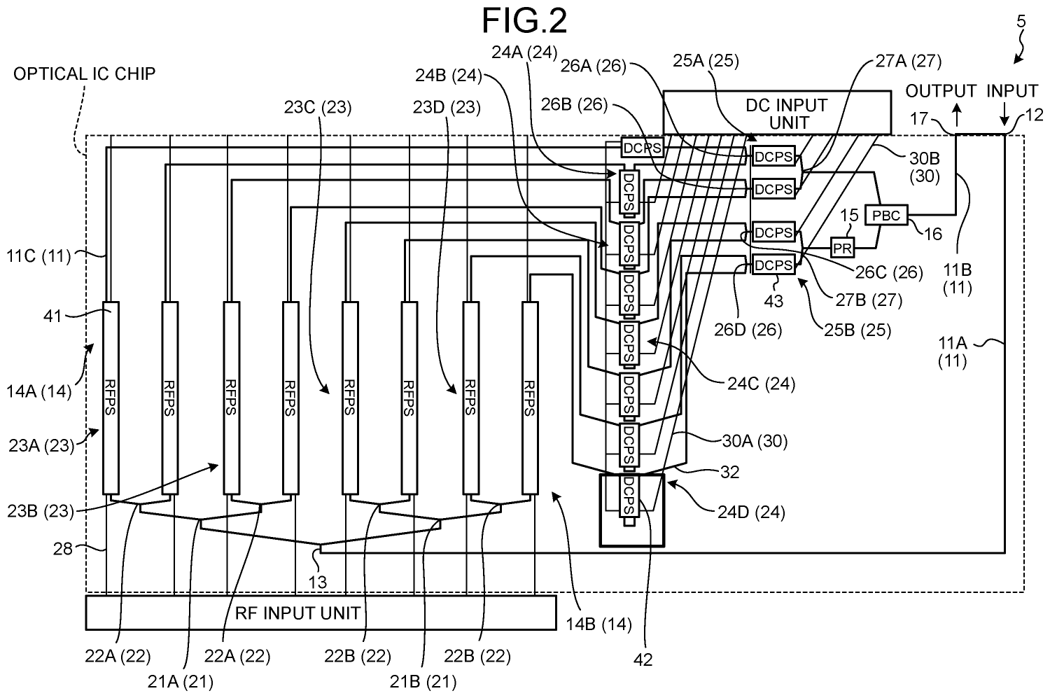

FIG. 2 is a block diagram illustrating an example of the optical modulator 5. The optical modulator 5 illustrated in FIG. 2 includes an optical waveguide 11, an optical input unit 12, a first split unit 13, an X-polarization MZM 14A (14), and a Y-polarization MZM 14B (14). The optical modulator 5 further includes a polarization rotator (PR) 15, a polarization beam combiner (PBC) 16, and an optical output unit 17.

The optical waveguide 11 includes an optical waveguide 11A, an optical waveguide 11B, and an optical waveguide 11C. The optical waveguide 11A is an optical waveguide that connects the optical input unit 12 and the first split unit 13. The optical waveguide 11B is an optical waveguide that connects a second multiplexing unit 27A (27) in the X-polarization MZM 14A and the optical output unit 17, and connects a second multiplexing unit 27B (27) in the Y-polarization MZM 14B and the optical output unit 17. The optical waveguide 11C is an optical waveguide that connects the first split unit 13 and the second multiplexing unit 27.

The optical input unit 12 receives input of laser light from the light source 4. The first split unit 13 optically splits the laser light coming from the optical input unit 12, and outputs the optically split laser light to the X-polarization MZM 14A and the Y-polarization MZM 14B.

The X-polarization MZM 14A performs quadrature amplitude modulation on the laser light, which has been split by the first split unit 13, by using an X-polarized data signal, and outputs signal light of an X-polarized IQ component to the PBC 16. The Y-polarization MZM 14B performs quadrature amplitude modulation on the laser light, which has been split by the first split unit 13, by using a Y-polarized data signal, and outputs signal light of a Y-polarized IQ component to the PR 15. The PR 15 performs polarization rotation on the signal light of the Y-polarized IQ component coming from the Y-polarization MZM 14B such that the signal light is converted to signal light of an X-polarized IQ component, and outputs the converted signal light of the X-polarized IQ component to the PBC 16. Further, the PBC 16 multiplexes the signal light of the X-polarized IQ component coming from the X-polarization MZM 14A and the converted signal light of the X-polarized IQ component coming from the PR 15, and outputs dual-polarized signal light to the optical output unit 17.

The X-polarization MZM 14A includes a second split unit 21A (21), two third split units 22 (22A), two RF-side MZMs 23 (23A and 23B), two DC-side child MZMs 24 (24A and 24B), and two first multiplexing units 26 (26A and 26B). Further, the X-polarization MZM 14A includes a DC-side parent MZM 25 (25A), the second multiplexing unit 27 (27A), and an adjustment unit 32.

The adjustment unit 32 is an optical waveguide that equalizes waveguide lengths of all of optical waveguides from the second split unit 21A to the second multiplexing unit 27A in the X-polarization MZM 14A. Further, the adjustment unit 32 in the X-polarization MZM 14A is an optical waveguide that equalizes waveguide lengths of all of optical waveguides from a second split unit 21B to the second multiplexing unit 27B in the Y-polarization MZM 14B and the waveguide lengths of all of the optical waveguides from the second split unit 21A to the second multiplexing unit 27A.

Each of the third split units 22A splits laser light coming from the second split unit 21A and outputs the split laser light to each of RFPSs 41 in the RF-side MZM 23A. The RF-side MZM 23A includes two RF electrodes 28 and the two RFPSs 41. Each of the RFPSs 41 in the RF-side MZM 23A performs high-speed modulation on the laser light in accordance with a high-speed signal coming from the RF electrode 28, and outputs the laser light subjected to the high-speed modulation to each of child DCPSs 42 in the DC-side child MZM 24A.

The DC-side child MZM 24A includes two DC electrodes 30A (30) and the two child DCPSs 42. The DC-side child MZM 24A is arranged above the adjustment unit 32. Each of the child DCPSs 42 in the DC-side child MZM 24A performs phase modulation on the laser light, which has been subjected to the high-speed modulation, in accordance with a data signal coming from the DC electrode 30A, and outputs signal light of an I component subjected to the phase modulation to the first multiplexing unit 26A. The first multiplexing unit 26A multiplexes the signal light of the I component coming from each of the child DCPSs 42, and outputs the multiplexed signal light of the I component to one of parent DCPSs 43 in the DC-side parent MZM 25A.

The DC-side child MZM 24B includes two DC electrodes 30A and two child DCPSs 42. The DC-side child MZM 24B is arranged above the adjustment unit 32. Each of the child DCPSs 42 in the DC-side child MZM 24B performs phase modulation on the laser light, which has been subjected to the high-speed modulation, in accordance with a data signal coming from the DC electrode 30A, and outputs signal light of a Q component subjected to the phase modulation to the first multiplexing unit 26B. The first multiplexing unit 26B multiplexes the signal light of the Q component coming from each of the child DCPSs 42, and outputs the multiplexed signal light of the Q component to the other one of the parent DCPSs 43 in the DC-side parent MZM 25A.

The DC-side parent MZM 25A includes two DC electrodes 30B (30) and the two parent DCPSs 43. One of the parent DCPSs 43 in the DC-side parent MZM 25A performs quadrature modulation on the signal light of the I component, which has been subjected to the phase modulation, in accordance with a driving voltage signal coming from the DC electrode 30B, and outputs signal light of an X-polarized I component subjected to the quadrature modulation to the second multiplexing unit 27A. The other one of the parents DCPS 43 in the DC-side parent MZM 25A performs quadrature modulation on the signal light of the Q component, which has been subjected to the phase modulation, in accordance with a driving voltage signal coming from the DC electrode 30B, and outputs signal light of an X-polarized Q component subjected to the quadrature modulation to the second multiplexing unit 27A.

The second multiplexing unit 27A multiplexes the signal light of the X-polarized I component coming from the one of the parent DCPSs 43 in the DC-side parent MZM 25A and the signal light of the X-polarized Q component coming from the other one of the parent DCPSs 43 in the DC-side parent MZM 25A. Then, the second multiplexing unit 27A outputs the multiplexed signal light of the X-polarized IQ component to the PBC 16.

The Y-polarization MZM 14B includes the second split unit 21B (21), two third split units 22B (22), two RF-side MZMs 23 (23C and 23D), and two DC-side child MZMs 24 (24C and 24D). Furthermore, the Y-polarization MZM 14B includes two first multiplexing units 26 (26C and 26D), a DC-side parent MZM 25 (25B), the second multiplexing unit 27 (27B), and an adjustment unit 32.

The adjustment unit 32 is an optical waveguide that equalizes the waveguide lengths of all of the optical waveguides from the second split unit 21B to the second multiplexing unit 27B in the Y-polarization MZM 14B. Further, the adjustment unit 32 in the Y-polarization MZM 14B is an optical waveguide that equalizes the waveguide lengths of all of the optical waveguides from the second split unit 21A to the second multiplexing unit 27A in the X-polarization MZM 14A and the waveguide lengths of all of the optical waveguides from the second split unit 21B to the second multiplexing unit 27B.

Each of the third split units 22B splits laser light coming from the second split unit 21B and outputs the split laser light to each of RFPSs 41 in the RF-side MZM 23C. The RF-side MZM 23C includes two RF electrodes 28 and the two RFPSs 41. Each of the RFPSs 41 in the RF-side MZM 23C performs high-speed modulation on the laser light in accordance with a high-speed signal coming from the RF electrode 28, and outputs the laser light subjected to the high-speed modulation to each of child DCPSs 42 in the DC-side child MZM 24C.

The DC-side child MZM 24C includes two DC electrodes 30A (30) and the two child DCPSs 42. The DC-side child MZM 24C is arranged above the adjustment unit 32. Each of the child DCPSs 42 in the DC-side child MZM 24C performs phase modulation on the laser light, which has been subjected to the high-speed modulation, in accordance with a data signal coming from the DC electrode 30A, and outputs signal light of an I component subjected to the phase modulation to the first multiplexing unit 26C. The first multiplexing unit 26C multiplexes the signal light of the I component from each of the child DCPSs 42, and outputs the multiplexed signal light of the I component to one of parent DCPS 43 in the DC-side parent MZM 25B.

The DC-side child MZM 24D includes two DC electrodes 30A and two child DCPSs 42. The DC-side child MZM 24D is arranged above the adjustment unit 32. Each of the child DCPSs 42 in the DC-side child MZM 24D performs phase modulation on the laser light, which has been subjected to the high-speed modulation, in accordance with a data signal coming from the DC electrode 30A, and outputs signal light of a Q component subjected to the phase modulation to the first multiplexing unit 26D. The first multiplexing unit 26D multiplexes the signal light of the Q component coming from each of the child DCPSs 42, and outputs the multiplexed signal light of the Q component to the other one of the parent DCPSs 43 in the DC-side parent MZM 25B.

The DC-side parent MZM 25B includes two DC electrodes 30B (30) and the two parent DCPSs 43. One of the parent DCPSs 43 in the DC-side parent MZM 25B performs quadrature modulation on the signal light of the I component, which has been subjected to the phase modulation, in accordance with a driving voltage signal coming from the DC electrode 30B, and outputs signal light of a Y-polarized I component subjected to the quadrature modulation to the second multiplexing unit 27B. The other one of the parent DCPSs 43 in the DC-side parent MZM 25B performs quadrature modulation on the signal light of the Q component, which has been subjected to the phase modulation, in accordance with the driving voltage signal coming from the DC electrode 30B, and outputs signal light of a Y-polarized Q component subjected to the quadrature modulation to the second multiplexing unit 27B.

The second multiplexing unit 27B multiplexes the signal light of the Y-polarized I component coming from the one of the parent DCPSs 43 in the DC-side parent MZM 25B and the signal light of the Y-polarized Q component coming from the other one of the parent DCPSs 43 in the DC-side parent MZM 25B. Then, the second multiplexing unit 27B outputs the multiplexed signal light of the Y-polarized IQ component to the PR 15. The PR 15 performs polarization rotation on the signal light of the Y-polarized IQ component coming from the second multiplexing unit 27B, and outputs the signal light of the X-polarized IQ component subjected to the polarization rotation to the PBC 16. The PBC 16 performs polarization multiplexing on the signal light of the X-polarized IQ component coming from the second multiplexing unit 27A and the signal light of the X-polarized IQ component coming from the PR 15, and outputs a dual-polarized signal to the optical output unit 17.

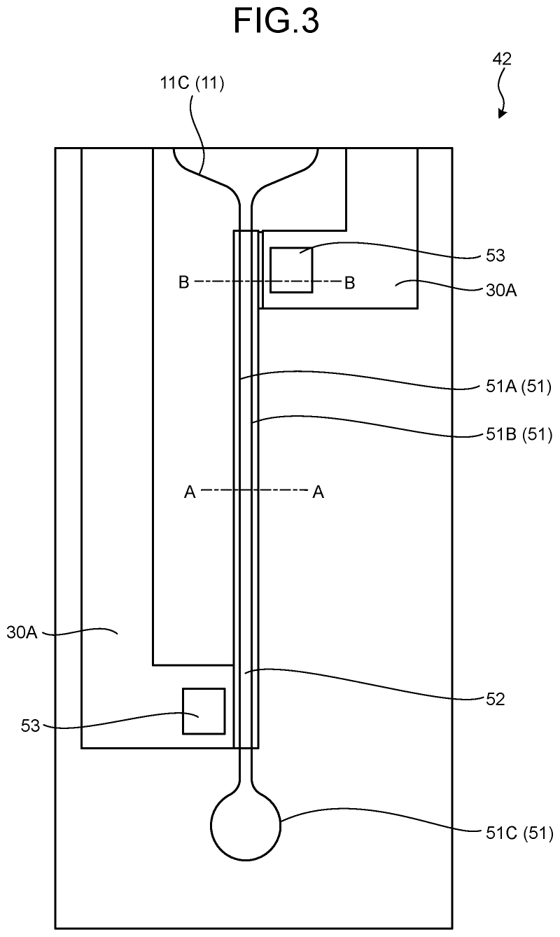

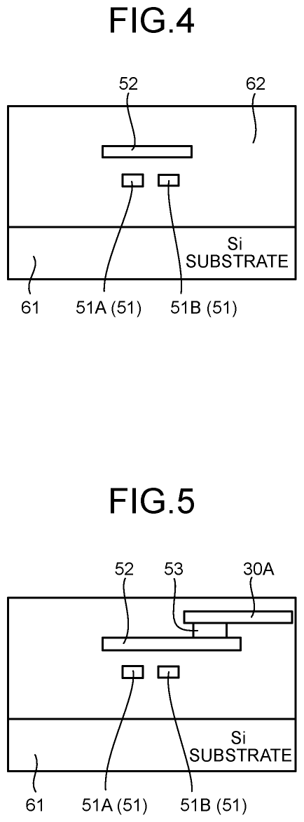

FIG. 3 is a schematic plan view illustrating an example of a configuration of the child DCPS 42, FIG. 4 is a schematic cross-sectional view illustrating an example of a cross section taken along a line A-A illustrated in FIG. 3, and FIG. 5 is a schematic cross-sectional view illustrating an example of a cross section taken along a line B-B illustrated in FIG. 3. The child DCPS 42 illustrated in FIG. 3 includes an in-shifter waveguide 51 through which signal light passes, and a heater electrode 52 that heats the in-shifter waveguide 51 in accordance with a driving voltage. The DC electrodes 30A are electrically connected to the heater electrode 52 via vias 53. The in-shifter waveguide 51 includes an inbound waveguide 51A for inputting signal light, an outbound waveguide 51B for outputting signal light, and a folded waveguide 51C that connects the inbound waveguide 51A and the outbound waveguide 51B. Meanwhile, the folded waveguide 51C is a waveguide that adjusts waveguide lengths such that the waveguide lengths of the optical waveguides of all of the MZMs in the optical modulator 5 become equal to one another, similarly to the adjustment unit 32. In other words, by adjusting the waveguide length of the folded waveguide 51C in each of the child DCPSs 42, the following waveguide lengths become equal to one another, for example: a waveguide length from the first split unit 13→the second split unit 21A→the third split unit 22A→the RFPS 41→the child DCPS 42→the first multiplexing unit 26A; a waveguide length from the first split unit 13→the second split unit 21A→the third split unit 22A→the RFPS 41→the child DCPS 42→the first multiplexing unit 26B; a waveguide length from the first split unit 13→the second split unit 21B→the third split unit 22B→the RFPS 41→the child DCPS 42→the first multiplexing unit 26C; and a waveguide length from the first split unit 13→the second split unit 21B→the third split unit 22B→the RFPS 41→the child DCPS 42→the first multiplexing unit 26D. Meanwhile, the MZMs in the optical modulator 5 are, for example, the RF-side MZMs 23, the DC-side child MZMs 24, and the DC-side parent MZMs 25.

In each of the child DCPSs 42, the heater electrode 52 is arranged in an upper part in the vicinity of the inbound waveguide 51A and the outbound waveguide 51B. In other words, the single heater electrode 52 heats the inbound waveguide 51A and the outbound waveguide 51B in the child DCPS 42.

The child DCPS 42 illustrated in FIG. 4 and FIG. 5 includes an Si substrate 61, a cladding layer 62 that is laminated on the Si substrate 61, and the inbound waveguide 51A and the outbound waveguide 51B of the in-shifter waveguide 51 in the cladding layer 62. Further, the child DCPS 42 includes the heater electrode 52 that is arranged above the inbound waveguide 51A and the outbound waveguide 51B in the cladding layer 62. The vias 53 electrically connect the heater electrode 52 and the DC electrodes 30A.

In the child DCPS 42 in the optical modulator 5 of the first embodiment, the heater electrode 52 is arranged in the upper part in the vicinity of the inbound waveguide 51A and the outbound waveguide 51B that are arranged parallel to each other. As a result, by using the folded waveguide 51C in the child DCPS 42 to adjust the waveguide, it is possible to reduce the size of the optical modulator 5 and it is possible to perform adjustment to equalize the waveguide lengths of all of the MZMs in the optical modulator 5. Furthermore, the inbound waveguide 51A and the outbound waveguide 51B sandwiching the folded waveguide 51C are heated by the single heater electrode 52, so that it is possible to adjust a phase of laser light by a small electric current, and it is possible to largely reduce power consumption of the heater electrode 52.

Meanwhile, the case has been described in which, in the optical modulator 5 of the first embodiment, the DC-side child MZMs 24 are arranged above the adjustment unit 32 between the RF-side MZMs 23 and the DC-side parent MZMs 25. However, it may be possible to arrange the DC-side child MZMs 24 between the RF-side MZMs 23 and the DC-side parent MZMs 25 without arranging the adjustment unit 32. In this case, it is possible to perform adjustment to equalize the waveguide lengths in all of the MZMs in the optical modulator 5 by adjusting the folded waveguide 51C in each of the child DCPSs 42 in the DC-side child MZMs 24.

Furthermore, the case has been described in which, in the optical modulator 5 of the first embodiment, the child DCPSs 42 are arranged above the adjustment unit 32 between the RFPSs 41 and the first multiplexing units 26, but embodiments are not limited to this example, and appropriate modification is applicable.

### [b] Second Embodiment

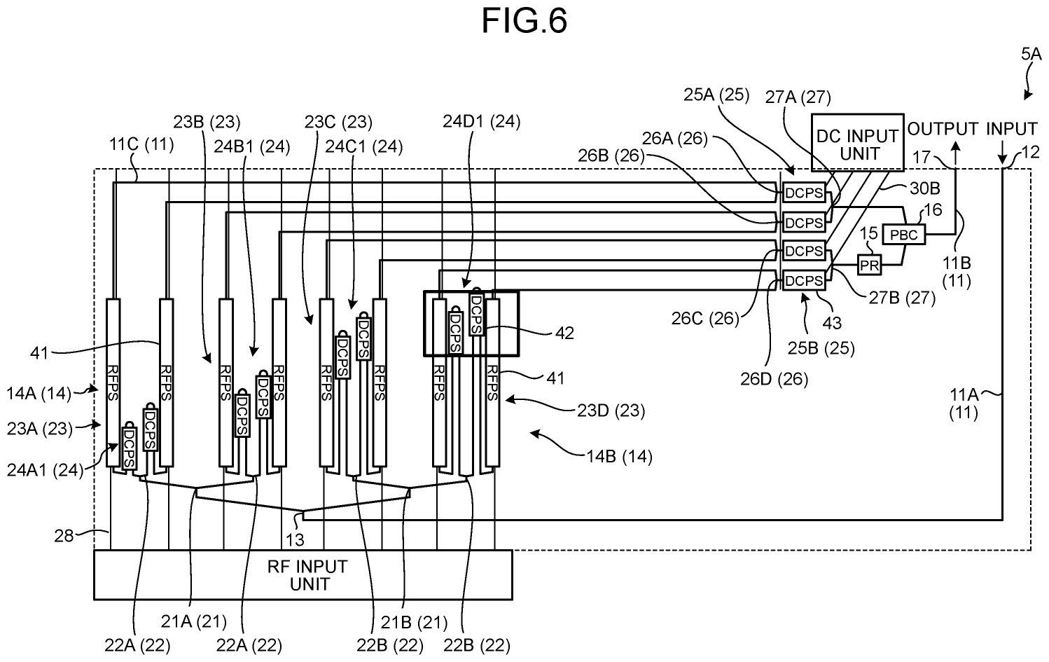

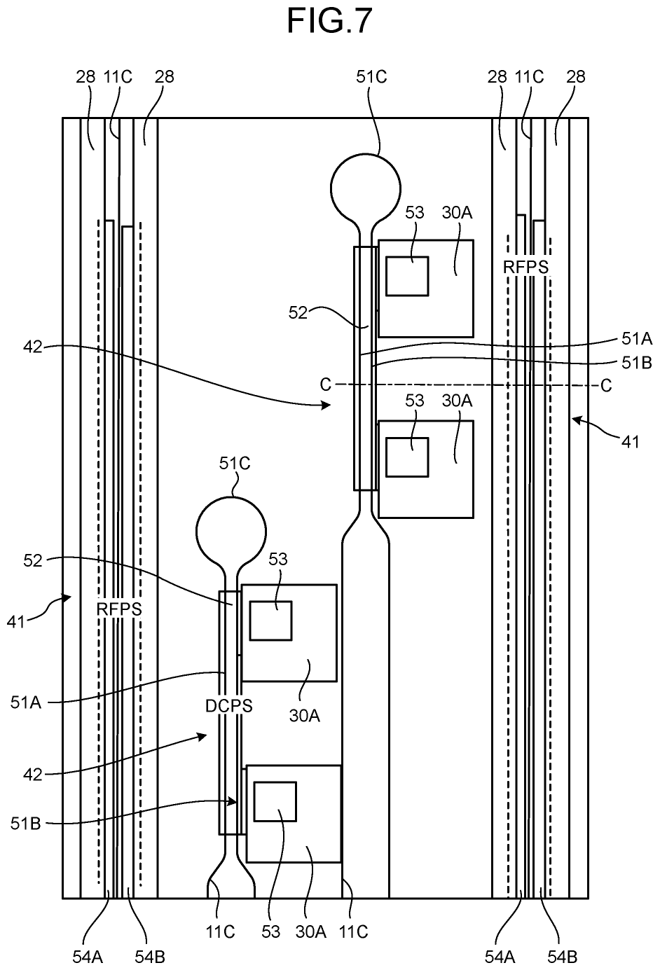

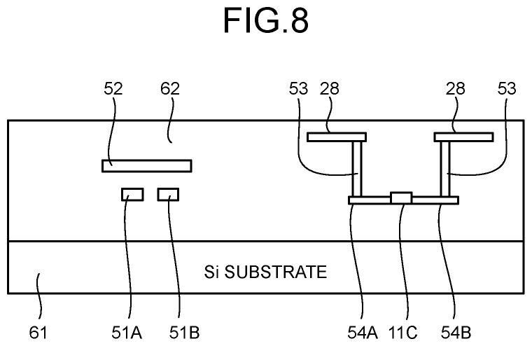

FIG. 6 is a schematic plan view illustrating an example of a configuration of an optical modulator 5A according to a second embodiment, FIG. 7 is a schematic plan view illustrating an example of a configuration of the child DCPS 42, and FIG. 8 is a schematic cross-sectional view illustrating an example of a cross section taken along a line C-C illustrated in FIG. 7. Meanwhile, the same components as those of the optical modulator 5 of the first embodiment are denoted by the same reference symbols, and explanation of the same components and operation will be omitted. The optical modulator 5A illustrated in FIG. 6 is different from the optical modulator 5 illustrated in FIG. 2 in that the adjustment unit 32 is omitted, and the child DCPSs 42 as a pair in each of the DC-side child MZMs 24 are arranged parallel to the RFPSs 41 as a pair in each of the RF-side MZMs 23 that is serially connected to the DC-side child MZM 24.

Furthermore, the DC-side child MZMs 24 and the RF-side MZMs 23 are arranged in this order between the third split units 22 and the first multiplexing units 26. Each of the third split units 22 splits the laser light and outputs the split light to each of the child DCPSs 42 in each of the DC-side child MZMs 24. Each of the child DCPSs 42 optically connects the third split unit 22 and the inbound waveguide 51A, and optically connects the outbound waveguide 51B and the RFPS 41.

In each of the DC-side child MZMs 24, one of the RFPSs 41, which is serially connected to one of the child DCPSs 42 as the pair, and the other one of the RFPSs 41, which is serially connected to the other one of the child DCPSs 42, are arranged parallel to each other. The one of the child DCPSs 42 is arranged parallel to one side surface, for example, on a left side in the figure, between two side surfaces of the one of the RFPSs 41. The other one of the child DCPSs 42 is arranged parallel to another side surface, for example, on a right side in the figure, which is different from the one side surface, between two side surfaces of the other one of the RFPSs 41. As a result, it is possible to arrange the pair of child DCPSs 42 in the DC-side child MZM 24 in a parallel manner between the pair of RFPSs 41 in the RF-side MZM 23 that is serially connected to the DC-side child MZM 24.

The DC-side child MZM 24 in the X-polarization MZM 14A illustrated in FIG. 6 includes a DC-side child MZM 24A1 and a DC-side child MZM 24B1. Further, the DC-side child MZM 24 in the Y-polarization MZM 14B includes a DC-side child MZM 24C1 and a DC-side child MZM 24D1.

Each of the DC-side child MZMs 24 (24A1, 24B1, 24C1, 24D1) illustrated in FIG. 7 and FIG. 8 includes the pair of child DCPSs 42. Each of the child DCPSs 42 includes the in-shifter waveguide 51 through which signal light passes and the heater electrode 52 that heats the in-shifter waveguide 51 in accordance with a driving voltage. The DC electrodes 30A are electrically connected the heater electrode 52 via the vias 53. The in-shifter waveguide 51 includes the inbound waveguide 51A for inputting signal light, the outbound waveguide 51B for outputting signal light, and the folded waveguide 51C that connects the inbound waveguide 51A and the outbound waveguide 51B.

By adjusting waveguide lengths of optical waveguides between the third split units 22 and the inbound waveguides 51A in the child DCPSs 42 and waveguide lengths of optical waveguides between the RFPSs 41 and the outbound waveguides 51B in the child DCPSs 42, the waveguide lengths of the optical waveguides of all of the MZMs in the optical modulator 5A become equal to one another. In other words, by adjusting the waveguide lengths of the optical waveguides that are optically connected to the inbound waveguides 51A and the outbound waveguides 51B in the child DCPSs 42, the following waveguide lengths become equal to one another, for example: a waveguide length from the first split unit 13→the second split unit 21A→the third split unit 22A→the child DCPS 42→the RFPS 41→the first multiplexing unit 26A; a waveguide length from the first split unit 13→the second split unit 21A→the third split unit 22A→the child DCPS 42→the RFPS 41→the first multiplexing unit 26B; a waveguide length from the first split unit 13→the second split unit 21B→the third split unit 22B→the child DCPS 42→the RFPS 41→the first multiplexing unit 26C; and a waveguide length from the first split unit 13→the second split unit 21B→the third split unit 22B→the child DCPS 42→the RFPS 41→the first multiplexing unit 26D.

In each of the child DCPSs 42, the heater electrode 52 is arranged in a lower part in the vicinity of the inbound waveguide 51A and the outbound waveguide 51B. In other words, the single heater electrode 52 heats the inbound waveguide 51A and the outbound waveguide 51B in each of the child DCPSs 42.

Each of the RF-side MZMs 23 includes the pair of RFPSs 41. Each of the RFPSs 41 includes the optical waveguide 11C, two RF electrodes 28, the vias 53, a P-doped layer 54A, and an N-doped layer 54B. One of the vias 53 electrically connects one of the RF electrodes 28 and the N-doped layer 54B. The other one of the vias 53 electrically connects the other one of the RF electrodes 28 and the P-doped layer 54A.

Each of the child DCPSs 42 inputs laser light coming from the third split unit 22 to the inbound waveguide 51A, and outputs laser light from the outbound waveguide 51B through the inbound waveguide 51A, the folded waveguide 51C, and the outbound waveguide 51B. Each of the child DCPSs 42 performs phase modulation on the laser light that passes through the in-shifter waveguide 51 by heating the inbound waveguide 51A and the outbound waveguide 51B in accordance with a driving voltage signal given to the heater electrode 52, and outputs the laser light subjected to the phase modulation to the RFPS 41 in the subsequent stage.

Each of the RFPSs 41 performs high-frequency modulation on the laser light that passes through the optical waveguide 11C by heating the optical waveguide 11C through which the laser light that is subjected to the phase modulation and that comes from the child DCPS 42 passes, in accordance with a high-frequency signal given to the RF electrodes 28, and outputs the laser light subjected to the high-frequency modulation to the first multiplexing unit 26.

The child DCPSs 42 as a pair in each of the DC-side child MZMs 24 are arranged between the RFPSs 41 as a pair in each of the RF-side MZMs 23, so that it is possible to reduce an arrangement space as compared to the first embodiment and it is possible to reduce the size of the optical modulator 5A. Furthermore, the inbound waveguide 51A and the outbound waveguide 51B sandwiching the folded waveguide 51C are heated by the single heater electrode 52, so that it is possible to adjust the phase of the laser light by a small electric current, and it is possible to largely reduce power consumption of the heater electrode 52.

Meanwhile, if the child DCPSs 42 as a pair in each of the DC-side child MZMs 24 are arranged between the RFPSs 41 as a pair in each of the RF-side MZMs 23, the child DCPSs 42 are located adjacent to each other, so that heat generated by both of the child DCPSs 42 may interfere with each other and operation may become unstable. Therefore, an embodiment that copes with the situation as described above will be described below as a third embodiment.

### [c] Third Embodiment

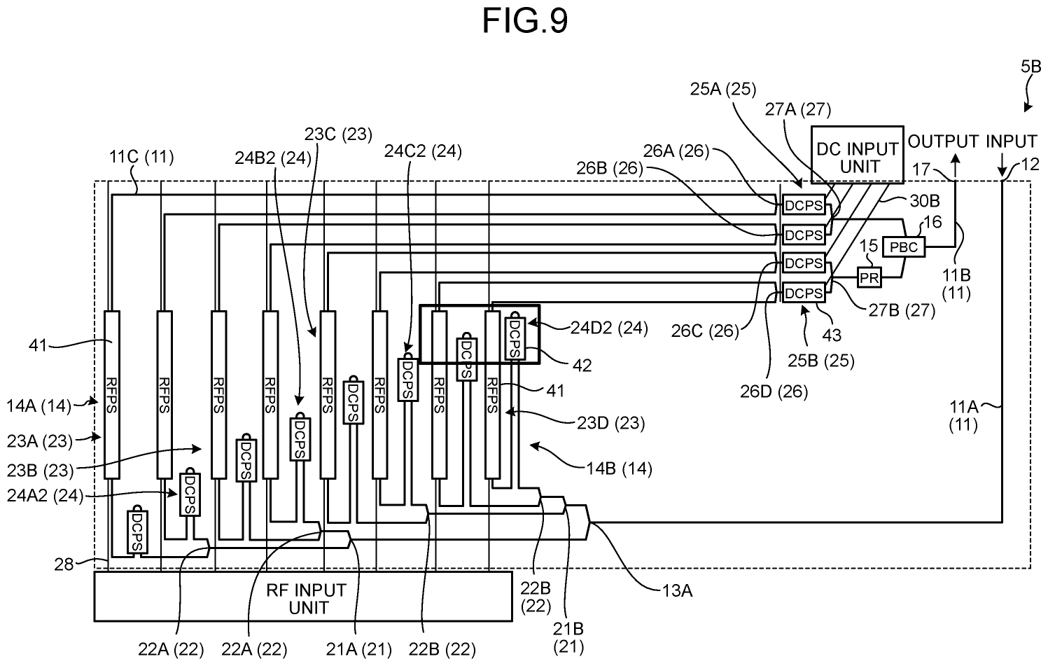

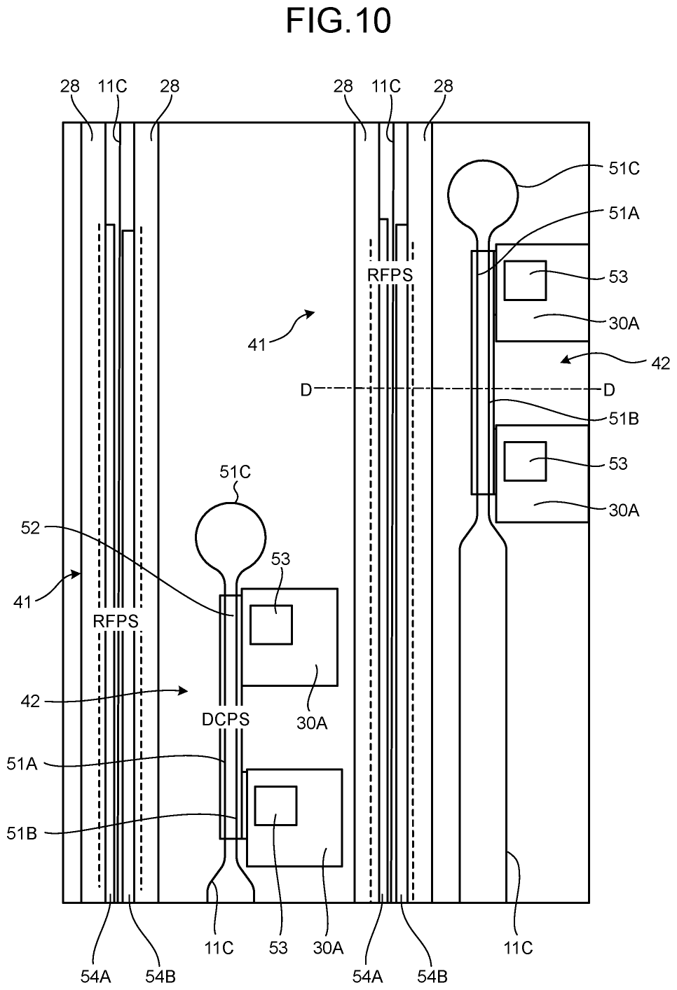

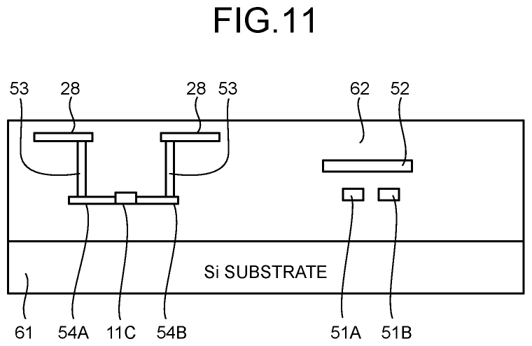

FIG. 9 is a schematic plan view illustrating an example of a configuration of an optical modulator 5B according to a third embodiment, FIG. 10 is a schematic plan view illustrating an example of a configuration of the child DCPS 42, and FIG. 11 is a schematic cross-sectional view illustrating an example of a cross section taken along a line D-D illustrated in FIG. 10. Meanwhile, the same components as those of the optical modulator 5 of the first embodiment are denoted by the same reference symbols, and explanation of the same components and operation will be omitted.

The optical modulator 5B illustrated in FIG. 9 is different from the optical modulator 5 illustrated in FIG. 2 in that the adjustment unit 32 is omitted, one of the child DCPSs 42 as a pair in each of the DC-side child MZMs 24 is arranged parallel to a right side surface of one of the RFPSs 41 as a pair in each of the RF-side MZMs 23, and the other one of the child DCPSs 42 is arranged parallel to a right side surface of the other one of the RFPSs 41.

The one of the child DCPSs 42 in each of the DC-side child MZMs 24 is arranged parallel to the right side surface of the RFPS 41 that is serially connected to the one of the child DCPSs 42. Further, the other one of the child DCPSs 42 in each of the DC-side child MZMs 24 is arranged parallel to the right side surface of the RFPS 41 that is serially connected to the other one of the child DCPSs 42. In other words, the child DCPSs 42 as a pair in the same DC-side child MZM 24 are separated from each other across the RFPS 41, so that it is possible to prevent thermal interference between the child DCPSs 42 in the same DC-side child MZM 24.

Furthermore, the DC-side child MZMs 24 and the RF-side MZMs 23 are arranged in this order between the third split units 22 and the first multiplexing units 26. Each of the third split units 22 splits the laser light and outputs the split laser light to each of the child DCPSs 42 in each of the DC-side child MZMs 24. Each of the child DCPSs 42 optically connects the third split unit 22 and the inbound waveguide 51A, and optically connects the outbound waveguide 51B and the RFPS 41.

An first split unit 13A is arranged at a position at which the waveguide length of the optical waveguide 11A from the optical input unit 12 is reduced as compared to the configuration illustrated in FIG. 2. As a result, it is possible to reduce a light propagation loss in the optical waveguide 11A.

In each of the DC-side child MZMs 24, one of the RFPSs 41, which is serially connected to one of the child DCPSs 42 as the pair, and the other one of the RFPSs 41, which is serially connected to the other one of the child DCPSs 42, are arranged parallel to each other. The one of the child DCPSs 42 is arranged parallel to one side surface, for example, on a right side in the figure, between two side surfaces of the one of the RFPSs 41. The other one of the child DCPSs 42 is arranged parallel to one side surface, for example, on a right side in the figure, between two side surfaces of the other one of the RFPSs 41.

The DC-side child MZM 24 in the X-polarization MZM 14A illustrated in FIG. 9 includes a DC-side child MZM 24A2 and a DC-side child MZM 24B2. Further, the DC-side child MZM 24 in the Y-polarization MZM 14B includes a DC-side child MZM 24C2 and a DC-side child MZM 24D2.

Each of the DC-side child MZMs 24 (24A2, 24B2, 24C2, 24D2) illustrated in FIG. 10 and FIG. 11 includes the pair of child DCPSs 42. Each of the child DCPSs 42 includes the in-shifter waveguide 51 through which signal light passes and the heater electrode 52 that heats the in-shifter waveguide 51 in accordance with a driving voltage. The DC electrodes 30A are electrically connected to the heater electrode 52 via the vias 53. The in-shifter waveguide 51 includes the inbound waveguide 51A for inputting signal light, the outbound waveguide 51B for outputting the signal light, and the folded waveguide 51C that connects the inbound waveguide 51A and the outbound waveguide 51B.

By adjusting waveguide lengths of optical waveguides between the third split units 22 and the inbound waveguides 51A in the child DCPSs 42 and waveguide lengths of optical waveguides between the RFPSs 41 and the outbound waveguides 51B in the child DCPSs 42, the waveguide lengths of the optical waveguides of all of the MZMs in the optical modulator 5B become equal to one another. In other words, by adjusting the waveguide lengths of the optical waveguides that are optically connected to the inbound waveguides 51A and the outbound waveguides 51B in the child DCPSs 42, the following waveguide lengths become equal to one another, for example: a waveguide length from the first split unit 13→the second split unit 21A→the third split unit 22A→the child DCPS 42→the RFPS 41→the first multiplexing unit 26A; a waveguide length from the first split unit 13→the second split unit 21A→the third split unit 22A→the child DCPS 42→the RFPS 41→the first multiplexing unit 26B; a waveguide length from the first split unit 13→the second split unit 21B→the third split unit 22B→the child DCPS 42→the RFPS 41→the first multiplexing unit 26C; and a waveguide length from the first split unit 13→the second split unit 21B→the third split unit 22B→the child DCPS 42→the RFPS 41→the first multiplexing unit 26D.

In each of the child DCPSs 42, the heater electrode 52 is arranged in a lower part in the vicinity of the inbound waveguide 51A and the outbound waveguide 51B. In other words, the single heater electrode 52 heats the inbound waveguide 51A and the outbound waveguide 51B in each of the child DCPSs 42.

Each of the RF-side MZMs 23 includes the pair of RFPSs 41. Each of the RFPSs 41 includes the optical waveguide 11C, the two RF electrodes 28, the vias 53, the P-doped layer 54A, and the N-doped layer 54B. One of the vias 53 electrically connects one of the RF electrodes 28 and the N-doped layer 54B. The other one of the vias 53 electrically connects the other one of the RF electrodes 28 and the P-doped layer 54A.

Each of the child DCPSs 42 inputs laser light coming from the third split unit 22 to the inbound waveguide 51A, and outputs laser light from the outbound waveguide 51B through the inbound waveguide 51A, the folded waveguide 51C, and the outbound waveguide 51B. Each of the child DCPSs 42 performs phase modulation on the laser light that passes through the in-shifter waveguide 51 by heating the inbound waveguide 51A and the outbound waveguide 51B in accordance with a driving voltage signal given to the heater electrode 52, and outputs the laser light subjected to the phase modulation to the RFPS 41 in the subsequent stage.

Each of the RFPSs 41 performs high-frequency modulation on the laser light that passes through the optical waveguide 11C by heating the optical waveguide 11C through which the laser light that is subjected to the phase modulation and that comes from the child DCPS 42 passes, in accordance with a high-frequency signal given to the RF electrode 28, and outputs the laser light subjected to the high-frequency modulation to the first multiplexing unit 26.

The one of the child DCPSs 42 in each of the DC-side child MZMs 24 of the third embodiment is arranged parallel to the right side surface of the RFPS 41 that is serially connected to the one of the child DCPSs 42. Further, the other one of the child DCPSs 42 in each of the DC-side child MZMs 24 is arranged parallel to the right side surface of the RFPS 41 that is serially connected to the other one of the child DCPSs 42. As a result, it is possible to reduce an arrangement space as compared to the first embodiment and it is possible to reduce the size of the optical modulator 5B. Furthermore, the child DCPSs 42 in each of the DC-side child MZMs 24 are separated from each other across the RFPS 41, so that it is possible to prevent thermal interference between the child DCPSs 42 in the same DC-side child MZM 24.

Meanwhile, the case has been described in which, in the optical modulator 5B of the third embodiment, the child DCPSs 42 in each of the DC-side child MZMs 24 are separated from each other across the RFPS 41. In this case, it is acceptable that heat of one of the child DCPSs 42 as a pair in each of the DC-side child MZMs 24 is transmitted to the RFPS 41 that is serially connected to the one of the child DCPSs 42. However, if heat of the other one of the child DCPSs 42 as a pair o is transmitted to the RFPS 41 that is serially connected to the one of the child DCPSs 42, noise occurs. Therefore, an embodiment that copes with the situation as describes above will be described below as a fourth embodiment.

### [d] Fourth Embodiment

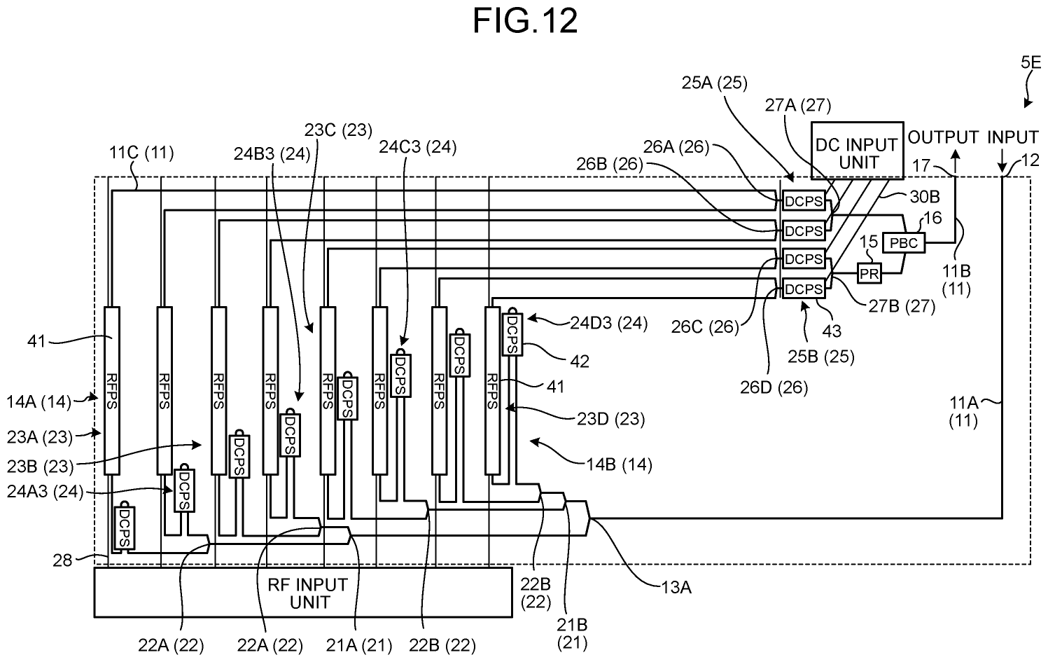

FIG. 12 is a schematic plan view illustrating an example of a configuration of an optical modulator 5E according to a fourth embodiment. Meanwhile, the same components as those of the optical modulator 5B of the third embodiment are denoted by the same reference symbols, and explanation of the same components and operation will be omitted. The optical modulator 5E illustrated in FIG. 12 is different from the optical modulator 5B illustrated in FIG. 9 in that one of the child DCPSs 42 as a pair in each of the DC-side child MZMs 24 is arranged so as to be adjacent and parallel to a right side surface of one of the RFPSs 41 that is serially connected to the one of the child DCPSs 42 between the RFPSs 41 as a pair in the RF-side MZM 23, and the other one of the child DCPSs 42 is arranged so as to be adjacent and parallel to a right side surface of the other one of the RFPSs 41 that is serially connected to the other one of the child DCPSs 42.

The one of the child DCPSs 42 in each of the DC-side child MZMs 24 is arranged so as to be adjacent and parallel to the right side surface of the RFPS 41 that is serially connected to the one of the child DCPSs 42. Further, the other one of the child DCPSs 42 in each of the DC-side child MZMs 24 is arranged so as to be adjacent and parallel to the right side surface of the RFPS 41 that is serially connected to the other one of the child DCPSs 42.

In other words, in the optical modulator 5B of the third embodiment, the child DCPSs 42 are arranged in an intermediate portion between the RFPSs 41, but in the optical modulator 5E of the fourth embodiment, each of the child DCPSs 42 is arranged in a portion adjacent to the right side surface of one of the RFPSs 41 between the RFPSs 41.

The DC-side child MZM 24 in the X-polarization MZM 14A illustrated in FIG. 12 includes a DC-side child MZM 24A3 and a DC-side child MZM 24B3. Further, the DC-side child MZM 24 in the Y-polarization MZM 14B includes a DC-side child MZM 24C3 and a DC-side child MZM 24D3.

In each of the DC-side child MZMs 24 (24A3, 24B3, 24C3, 24D3) of the fourth embodiment, one of the child DCPSs 42 is arranged so as to be adjacent and parallel to the right side surface of the RFPS 41 that is serially connected to the one of the child DCPSs 42. Further, the other one of the child DCPSs 42 in each of the DC-side child MZMs 24 (24A3, 24B3, 24C3, 24D3) is arranged so as to be adjacent and parallel to the right side surface of the RFPS 41 that is serially connected to the other one of the child DCPSs 42. As a result, the RFPS 41 is not sandwiched between the child DCPSs 42 as a pair at equal intervals, so that it is possible to prevent a situation in which heat from the pair of child DCPSs 42 interferes with the RFPS 41 from both sides. It is possible to prevent a situation in which heat from the other one of the child DCPSs 42 as a pair causes noise with respect to the RFPS 41 that is serially connected to the one of the child DCPSs 42.

### [e] Fifth Embodiment

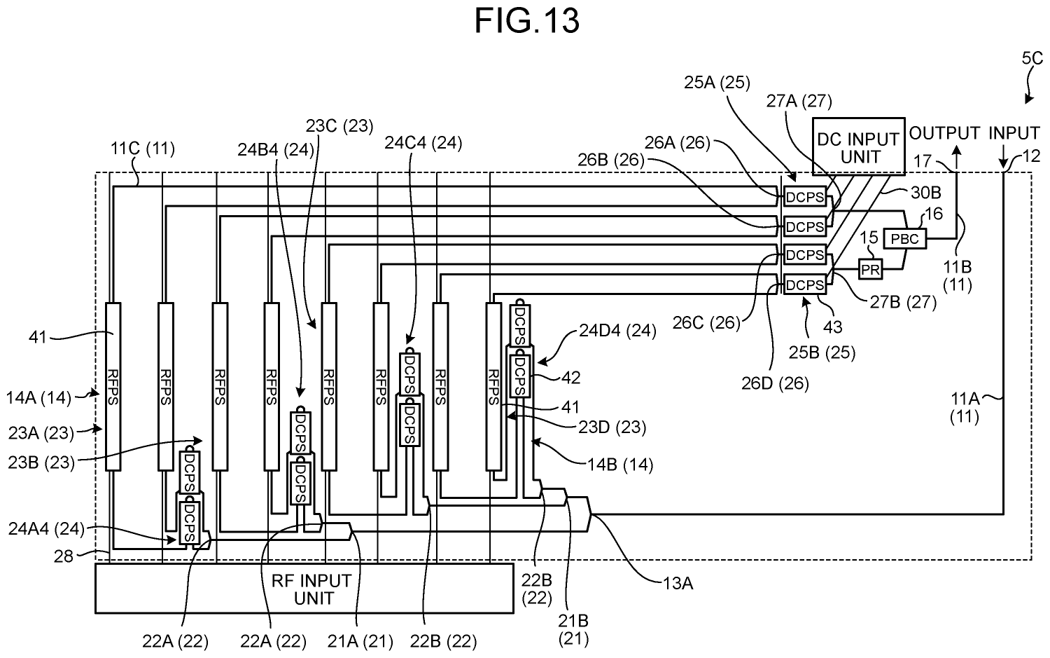

FIG. 13 is a schematic plan view illustrating an example of a configuration of an optical modulator 5C according to a fifth embodiment. Meanwhile, the same components as those of the optical modulator 5 of the first embodiment are denoted by the same reference symbols, and explanation of the same components and operation will be omitted. The optical modulator 5C illustrated in FIG. 13 is different from the optical modulator 5 illustrated in FIG. 2 in that the child DCPSs 42 as a pair in each of the DC-side child MZMs 24 that is serially connected to each of the RF-side MZMs 23 are arranged in series at a side of one side surface, for example, on a right side surface, of one of the RFPSs 41 as a pair in the RF-side MZM 23.

In each of the DC-side child MZMs 24, one of the RFPSs 41 that is serially connected to one of the child DCPSs 42 as a pair and the other one of the RFPSs 41 that is serially connected to the other one of the child DCPSs 42 are arranged parallel to each other. One of the child DCPSs 42 in each of the DC-side child MZM 24 is arranged parallel to the right side surface of one of the RFPSs 41 that is serially connected to the one of the child DCPSs 42. Further, the other one of the child DCPSs 42 in each of the DC-side child MZMs 24 is arranged so as to be located below the one of the child DCPSs 42 and so as to be parallel to the right side surface of the one of the RFPSs 41.

Moreover, the DC-side child MZMs 24 and the RF-side MZMs 23 are arranged in this order between the third split units 22 and the first multiplexing units 26. Each of the third split units 22 splits laser light and outputs the split laser light to each of the child DCPSs 42 in each of the DC-side child MZMs 24. Each of the child DCPSs 42 optically connects the third split unit 22 and the inbound waveguide 51A, and optically connects the outbound waveguide 51B and the RFPS 41.

The DC-side child MZM 24 in the X-polarization MZM 14A illustrated in FIG. 13 includes a DC-side child MZM 24A4 and a DC-side child MZM 24B4. Further, the DC-side child MZM 24 in the Y-polarization MZM 14B includes a DC-side child MZM 24C4 and a DC-side child MZM 24D4.

Each of the DC-side child MZMs 24 (24A4, 24B4, 24C4, 24D4) illustrated in FIG. 13 includes the pair of child DCPSs 42. Each of the child DCPSs 42 includes the in-shifter waveguide 51 through which signal light passes and the heater electrode 52 that heats the in-shifter waveguide 51 in accordance with a driving voltage. The DC electrodes 30A are electrically connected the heater electrode 52 via the vias 53. The in-shifter waveguide 51 includes the inbound waveguide 51A for inputting signal light, the outbound waveguide 51B for outputting the signal light, and the folded waveguide 51C that connects the inbound waveguide 51A and the outbound waveguide 51B.

By adjusting waveguide lengths of optical waveguides between the third split units 22 and the inbound waveguides 51A in the child DCPSs 42 and waveguide lengths of optical waveguides between the RFPSs 41 and the outbound waveguides 51B in the child DCPSs 42, the waveguide lengths of the optical waveguides of all of the MZMs in the optical modulator 5C become equal to one another. In other words, by adjusting the waveguide lengths of the optical waveguides that are optically connected to the inbound waveguides 51A and the outbound waveguides 51B in the child DCPSs 42, the following waveguide lengths become equal to one another, for example: a waveguide length from the first split unit 13→the second split unit 21A→the third split unit 22A→the child DCPS 42→the RFPS 41→the first multiplexing unit 26A; a waveguide length from the first split unit 13→the second split unit 21A→the third split unit 22A→the child DCPS 42→the RFPS 41→the first multiplexing unit 26B; a waveguide length from the first split unit 13→the second split unit 21B→the third split unit 22B→the child DCPS 42→the RFPS 41→the first multiplexing unit 26C; and a waveguide length from the first split unit 13→the second split unit 21B→the third split unit 22B→the child DCPS 42→the RFPS 41→the first multiplexing unit 26D.

In each of the child DCPSs 42, the heater electrode 52 is arranged in a lower part in the vicinity of the inbound waveguide 51A and the outbound waveguide 51B. In other words, the single heater electrode 52 heats the inbound waveguide 51A and the outbound waveguide 51B in each of the child DCPSs 42.

Each of the RF-side MZMs 23 includes the pair of RFPSs 41. Each of the RFPSs 41 includes the optical waveguide 11C, the two RF electrodes 28, the vias 53, the P-doped layer 54A, and the N-doped layer 54B. One of the vias 53 electrically connects one of the RF electrodes 28 and the N-doped layer 54B. The other one of the vias 53 electrically connects the other one of the RF electrodes 28 and the P-doped layer 54A.

Each of the child DCPSs 42 inputs laser light coming from the third split unit 22 to the inbound waveguide 51A, and outputs laser light from the outbound waveguide 51B through the inbound waveguide 51A, the folded waveguide 51C, and the outbound waveguide 51B. Each of the child DCPSs 42 performs phase modulation on the laser light that passes through the in-shifter waveguide 51 by heating the inbound waveguide 51A and the outbound waveguide 51B in accordance with a driving voltage signal given to the heater electrode 52, and outputs the laser light subjected to the phase modulation to the RFPS 41 in the subsequent stage.

Each of the RFPSs 41 performs high-frequency modulation on the laser light that passes through the optical waveguide 11C by heating the optical waveguide 11C through which the laser light that is subjected to the phase modulation and that comes from the child DCPS 42 passes, in accordance with a high-frequency signal given to the RF electrode 28, and outputs the laser light subjected to the high-frequency modulation to the first multiplexing unit 26.

In the optical modulator 5C of the fifth embodiment, the child DCPSs 42 as a pair in each of the DC-side child MZMs 24 that is serially connected to each of the RF-side MZMs 23 are arranged in series on the right side surface of the pair of RFPSs 41 in the RF-side MZM 23. As a result, it is possible to reduce an arrangement space as compared to the first embodiment and it is possible to reduce the size of the optical modulator 5C. Furthermore, the inbound waveguide 51A and the outbound waveguide 51B sandwiching the folded waveguide 51C are heated by the single heater electrode 52, so that it is possible to adjust the phase of the laser light by a small electric current, and it is possible to largely reduce power consumption of the heater electrode 52.

### [f] Sixth Embodiment

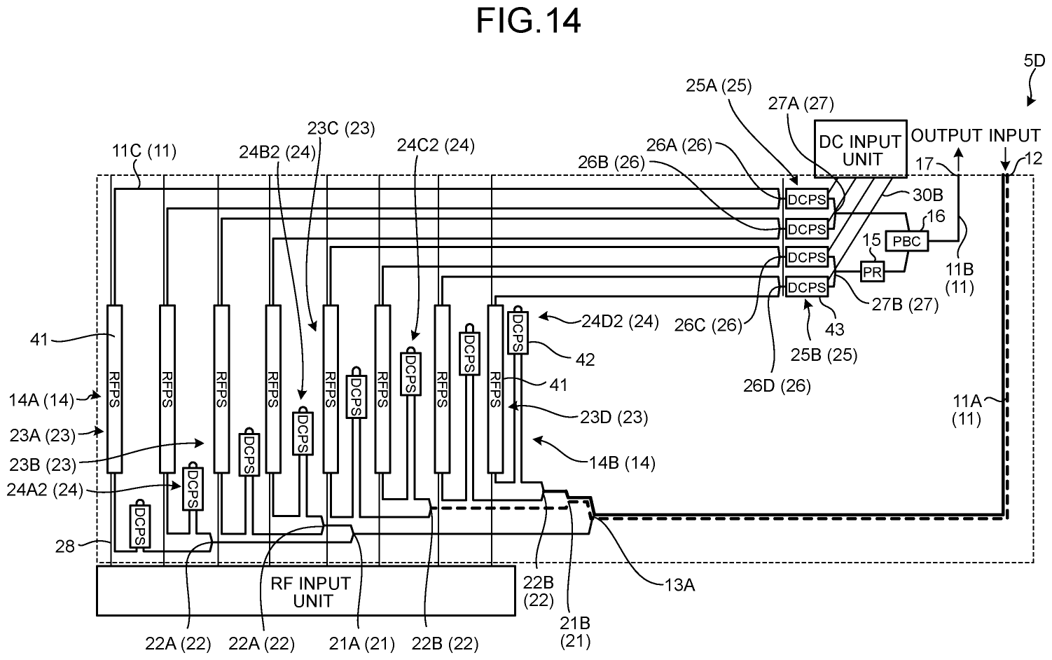

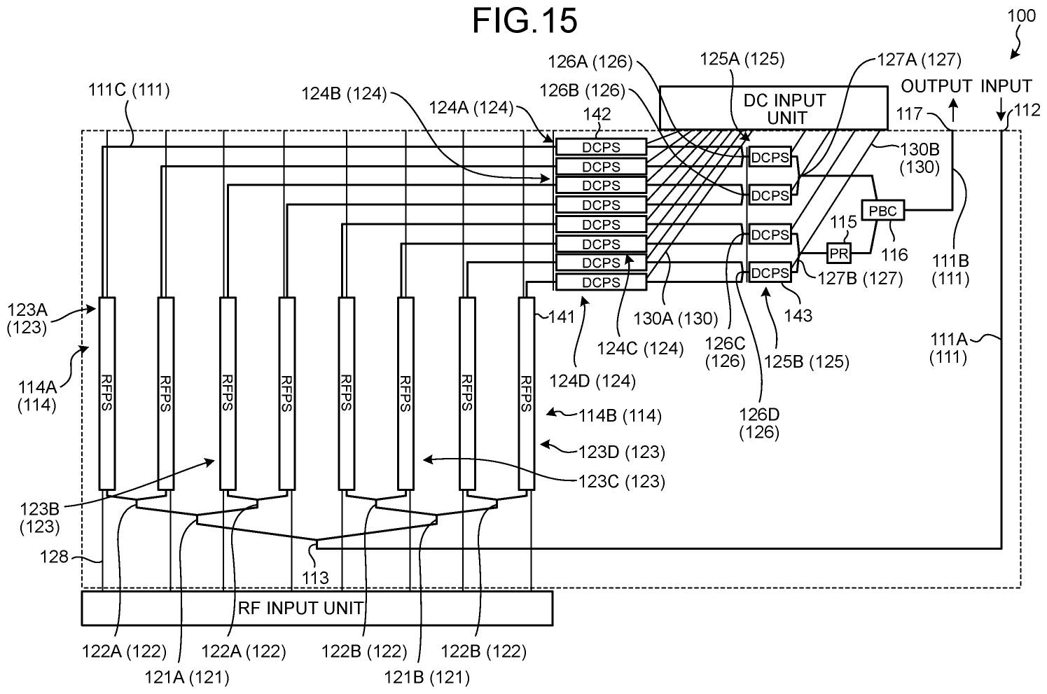

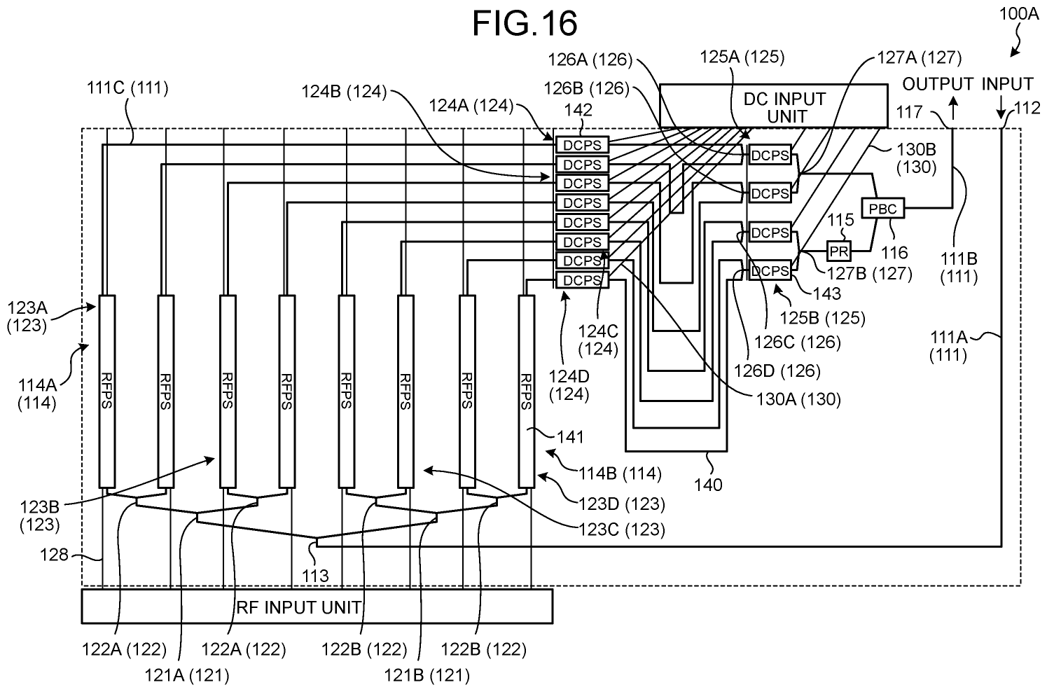

FIG. 14 is a schematic plan view illustrating an example of a configuration of an optical modulator 5D according to a sixth embodiment. Meanwhile, the same components as those of the optical modulator 5 of the first embodiment are denoted by the same reference symbols, and explanation of the same components and operation will be omitted. The optical modulator 5D illustrated in FIG. 14 is different from the optical modulator 5 illustrated in FIG. 2 in that one of the child DCPSs 42 as a pair in each of the DC-side child MZMs 24 is arranged parallel to a right side surface of one of the RFPSs 41 as a pair in the RF-side MZM 23 that is serially connected to the DC-side child MZM 24, and the other one of the child DCPSs 42 is arranged parallel to a right side surface of the other one of the RFPSs 41. Further, it is assumed that L1 represents a waveguide length of the optical waveguide 11A between the optical input unit 12 and the second split unit 21B, and L2 represents a waveguide length of the optical waveguide 11A between the optical input unit 12 and the second split unit 21A. Moreover, it is assumed that L3 represents a waveguide length of the optical waveguide 11A between the optical input unit 12 and the third split unit 22B, and L4 represents a waveguide length of the optical waveguide 11A between the optical input unit 12 and the third split unit 22A. Furthermore, the waveguide lengths are set such that L4<L3<L2<L1. In other words, the waveguide lengths of the optical waveguides 11 to the optical input unit 12 for the respective RF-side MZMs 23 are different from one another. In the optical modulator 5D illustrated in FIG. 14, it is possible to reduce the waveguide lengths of the optical waveguides 11A between the optical input unit 12 and the second split units 21 as compared to the optical modulator 5 illustrated in FIG. 2.

Moreover, the DC-side child MZMs 24 and the RF-side MZMs 23 are arranged in this order between the third split units 22 and the first multiplexing units 26. Each of the third split units 22 splits the laser light and outputs the split laser light to each of the child DCPSs 42 in each of the DC-side child MZMs 24. Each of the child DCPSs 42 optically connects the third split unit 22 and the inbound waveguide 51A, and optically connects the outbound waveguide 51B and the RFPS 41.

The DC-side child MZM 24 in the X-polarization MZM 14A illustrated in FIG. 14 includes the DC-side child MZM 24A2 and the DC-side child MZM 24B2. Further, the DC-side child MZM 24 in the Y-polarization MZM 14B includes the DC-side child MZM 24C2 and the DC-side child MZM 24D2.

Each of the DC-side child MZMs 24 (24A2, 24B2, 24C2, 24D2) illustrated in FIG. 10 and FIG. 11 includes the pair of child DCPSs 42. Each of the child DCPSs 42 includes the in-shifter waveguide 51 through which signal light passes and the heater electrode 52 that heats the in-shifter waveguide 51 in accordance with a driving voltage. The DC electrodes 30A are electrically connected to the heater electrode 52 via the vias 53. The in-shifter waveguide 51 includes the inbound waveguide 51A for inputting signal light, the outbound waveguide 51B for outputting the signal light, and the folded waveguide 51C that connects the inbound waveguide 51A and the outbound waveguide 51B.

By adjusting waveguide lengths of optical waveguides between the third split units 22 and the inbound waveguides 51A in the child DCPSs 42 and waveguide lengths of optical waveguides between the RFPSs 41 and the outbound waveguides 51B in the child DCPSs 42, the waveguide lengths of the optical waveguides of all of the MZMs in the optical modulator 5D become equal to one another. In other words, by adjusting the waveguide lengths of the optical waveguides that are optically connected to the inbound waveguides 51A and the outbound waveguides 51B in the child DCPSs 42, the following waveguide lengths become equal to one another, for example: a waveguide length from the first split unit 13→the second split unit 21A→the third split unit 22A→the child DCPS 42→the RFPS 41→the first multiplexing unit 26A; a the waveguide length from the first split unit 13→the second split unit 21A→the third split unit 22A→the child DCPS 42→the RFPS 41→the first multiplexing unit 26B; a waveguide length from the first split unit 13→the second split unit 21B→the third split unit 22B→the child DCPS 42→the RFPS 41→the first multiplexing unit 26C; and a waveguide length from the first split unit 13→the second split unit 21B→the third split unit 22B→the child DCPS 42→the RFPS 41→the first multiplexing unit 26D.

In each of the child DCPSs 42, the heater electrode 52 is arranged in a lower part in the vicinity of the inbound waveguide 51A and the outbound waveguide 51B. In other words, the single heater electrode 52 heats the inbound waveguide 51A and the outbound waveguide 51B in each of the child DCPSs 42.

Each of the RF-side MZMs 23 includes the pair of RFPSs 41. Each of the RFPSs 41 includes the optical waveguide 11C, the two RF electrodes 28, the vias 53, the P-doped layer 54A, and the N-doped layer 54B. One of the vias 53 electrically connects one of the RF electrodes 28 and the N-doped layer 54B. The other one of the vias 53 electrically connects the other one of the RF electrodes 28 and the P-doped layer 54A.

Each of the child DCPSs 42 inputs laser light coming from the third split unit 22 to the inbound waveguide 51A, and outputs laser light from the outbound waveguide 51B through the inbound waveguide 51A, the folded waveguide 51C, and the outbound waveguide 51B. Each of the child DCPSs 42 performs phase modulation on the laser light that passes through the in-shifter waveguide 51 by heating the inbound waveguide 51A and the outbound waveguide 51B in accordance with a driving voltage signal given to the heater electrode 52, and outputs the laser light subjected to the phase modulation to the RFPS 41 in the subsequent stage.

Each of the RFPSs 41 performs high-frequency modulation on the laser light that passes through the optical waveguide 11C by heating the optical waveguide 11C through which the laser light that is subjected to the phase modulation and that comes from the child DCPS 42 passes, in accordance with a high-frequency signal given to the RF electrode 28, and outputs the laser light subjected to the high-frequency modulation to the first multiplexing unit 26.

The one of the child DCPSs 42 as a pair in each of the DC-side child MZMs 24 of the sixth embodiment is arranged parallel to the right side surface of one of the RFPSs 41 as a pair in each of the RF-side MZMs 23, and the other one of the child DCPSs 42 is arranged parallel to the right side surface of the other one of the RFPSs 41. As a result, it is possible to reduce an arrangement space as compared to the first embodiment and it is possible to reduce the size of the optical modulator 5D.

Furthermore, in the optical modulator 5D, the waveguide lengths of the optical waveguides 11A from the optical input unit 12 to the second split unit 21 are different from one another for the respective RF-side MZMs 23. In the optical modulator 5D, for example, the waveguide length L4 of the optical waveguide 11A of the RF-side MZM 23D is reduced as compared to the waveguide length L1 of the optical waveguide 11A of the RF-side MZM 23A, so that it is possible to reduce a light propagation loss.

Meanwhile, for convenience of explanation, the case has been described in which the phase shifter of the embodiments are adopted to the child DCPSs 42 in the optical modulator 5, but it may be possible to adopt the phase shifter of the embodiments to Mach-Zehnder interferometers in the optical receiver 6 in the optical communication apparatus 1, and appropriate modification is applicable.

In the present embodiment, a dual-polarization method in which the X-polarized signal light from the X-polarization MZM 14A and the Y-polarized signal light from the Y-polarization MZM 14B are subjected to dual polarization is adopted, but the technology is also applicable to an optical modulator of a type in which dual polarization is not performed, for example.

According to one embodiment of an optical modulator disclosed in the present application, it is possible to reduce a size of the optical modulator and equalize waveguide lengths of all of optical waveguides in the optical modulator.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An optical modulator comprising:
an optical waveguide through which signal light passes;
a split unit that splits the signal light that passes through the optical waveguide; and
a pair of phase shifters, each shifting a phase of signal light that is split by the split unit, wherein
each of the phase shifters includes
an in-shifter waveguide through which the signal light passes; and
a heater electrode that heats the in-shifter waveguide in accordance with a driving voltage, and
the in-shifter waveguide includes
an inbound waveguide for inputting the signal light coming from the split unit;
an outbound waveguide for outputting the signal light; and
a folded waveguide that connects the inbound waveguide and the outbound waveguide, and
the heater electrode is arranged in a vicinity of the inbound waveguide and the outbound waveguide.

2. The optical modulator according to claim 1, wherein
one of high-frequency phase shifters that is serially connected to one of the phase shifters as the pair and another one of the high-frequency phase shifters that is serially connected to the other one of the phase shifters are arranged parallel to each other,
the one of the phase shifters is arranged parallel to one side surface between two side surfaces of the one of the high-frequency phase shifters, and
the other one of the phase shifters is arranged parallel to another side surface that is different from the one side surface between two side surfaces of the other one of the high-frequency phase shifters.

3. The optical modulator according to claim 1, wherein
one of high-frequency phase shifters that is serially connected to one of the phase shifters as the pair and another one of the high-frequency phase shifters that is serially connected to the other one of the phase sifters are arranged parallel to each other,
the one of the phase shifters is arranged parallel to one side surface between two side surfaces of the one of the high-frequency phase shifters, and
the other one of the phase shifters is arranged parallel to the one side surface between two side surfaces of the other one of the high-frequency phase shifters.

4. The optical modulator according to claim 1, wherein
one of high-frequency phase shifters that is serially connected to one of the phase shifters as the pair and another one of the high-frequency phase shifters that is serially connected to the other one of the phase shifters are arranged parallel to each other,
the one of the phase shifters is arranged so as to be adjacent and parallel to one side surface between two side surfaces of the one of the high-frequency phase shifters, and
the other one of the phase shifters is arranged so as to be adjacent and parallel to the one side surface between two side surfaces of the other one of the high-frequency phase shifters.

5. The optical modulator according to claim 1, wherein
one of high-frequency phase shifters that is serially connected to one of the phase shifters as the pair and another one of the high-frequency phase shifters that is serially connected to the other one of the phase shifters are arranged parallel to each other,
the one of the phase shifters is arranged parallel to one side surface between two side surfaces of the one of the high-frequency phase shifters, and
the other one of the phase shifters is arranged parallel to the one side surface of the one of the high-frequency phase shifters and is arranged in series with respect to the one of the phase shifters.

6. The optical modulator according to claim 1, further including:
an optical waveguide through which signal light passes;
an input unit for inputting the signal light to the optical waveguide;
a split unit that splits the signal light that passes through the optical waveguide; and
a pair of optical modulators, each modulating signal light split that is split by the split unit, wherein
a phase shifter in the optical modulator includes
an in-shifter waveguide through which the signal light passes; and
a heater electrode that heats the in-shifter waveguide in accordance with a driving voltage,
the in-shifter waveguide includes
an inbound waveguide for inputting the signal light from the split unit;
an outbound waveguide for outputting the signal light; and
a folded waveguide that connects the inbound waveguide and the outbound waveguide,
the heater electrode is arranged in a vicinity of the inbound waveguide and the outbound waveguide, and
a waveguide length from the input unit to one of the optical modulators and a waveguide length from the input unit to another one of the optical modulators are different from each other.

7. A phase shifter comprising:
an in-shifter waveguide through which signal light passes; and
a heater electrode that heats the in-shifter waveguide in accordance with a driving voltage, wherein
the phase shifter shifts a phase of the signal light that passes through the in-shifter waveguide, in accordance with heating performed by the heater electrode,
the in-shifter waveguide includes
an inbound waveguide for inputting the signal light;
an outbound waveguide for outputting the signal light; and
a folded waveguide that connects the inbound waveguide and the outbound waveguide, and
the heater electrode is arranged in a vicinity of the inbound waveguide and the outbound waveguide.

8. An optical communication apparatus comprising:
a processor that performs signal processing on an electric signal;
a light source that emits light; and
an optical modulator that modulates light emitted from the light source by using an electric signal output by the processor, wherein
a phase shifter in the optical modulator includes
an in-shifter waveguide through which the light passes; and
a heater electrode that heats the in-shifter waveguide in accordance with a driving voltage,
the phase shifter shifts a phase of the light that passes through the in-shifter waveguide in accordance with heating performed by the heater electrode,
the in-shifter waveguide includes
an inbound waveguide for inputting the light;
an outbound waveguide for outputting the light; and
a folded waveguide that connects the inbound waveguide and the outbound waveguide, and
the heater electrode is arranged in a vicinity of the inbound waveguide and the outbound waveguide.
